(19) United States
(12) Patent Application Publication
(10) Pub. No.: US 2023/0325971 A1
(43) Pub. Date: Oct. 12, 2023

(54) IMAGE SYNTHESIS DEVICE, IMAGE SYNTHESIS METHOD, AND STORAGE MEDIUM STORING PROGRAM

(71) Applicants: Mitsubishi Electric Corporation, Tokyo (JP); THE RITSUMEIKAN TRUST, Kyoto-shi (JP)

(72) Inventors: Kento YAMAZAKI, Tokyo (JP); Tsukasa FUKASAWA, Tokyo (JP); Kohei OKAHARA, Tokyo (JP); Fumihisa SHIBATA, Shiga (JP)

(73) Assignees: Mitsubishi Electric Corporation, Tokyo (JP); THE RITSUMEIKAN TRUST, Kyoto-shi (JP)

(21) Appl. No.: 18/210,310

(22) Filed: Jun. 15, 2023

Related U.S. Application Data
(63) Continuation of application No. PCT/JP2021/002472, filed on Jan. 25, 2021.

(51) Int. Cl. G06T 3/40; G06T 7/13

(52) U.S. Cl. CPC G06T 3/4038; G06T 2207/20221; G06T 7/13

(57) ABSTRACT

An image synthesis device includes processing circuitry to acquire a plurality of images captured from different viewpoints and to select images adjoining each other from the plurality of images; to calculate an overlap region as a region where the adjoining images overlap with each other; to determine a boundary line between images in the overlap region; and to execute blending of images in the overlap region. When at least one of the adjoining images includes a priority region, the processing circuitry determines the boundary line that does not overlap with a blend region in a vicinity of the priority region as a region determined depending on a blending method used for blending of an image of the priority region, and the processing circuitry executes the blending of the images in the overlap region based on the boundary line.

### CROSS-REFERENCE TO RELATED APPLICATION

This application is a continuation application of International Application No. PCT/JP2021/002472 having an international filing date of Jan. 25, 2021.

### BACKGROUND OF THE INVENTION

### 1. Field of the Invention

The present disclosure relates to an image synthesis device, an image synthesis method and a storage medium storing program.

### 2. Description of the Related Art

Image stitching technology is used for combining a plurality of images together. In the field of this technology, various proposals have been made in regard to issues such as how images adjoining each other, among a plurality of images captured by cameras at/in different positions/postures (i.e., captured from different viewpoints), should be geometrically placed to overlap with each other and how the blending should be performed on images in an overlap region as a region where images overlap with each other.

For example, Patent Reference 1 proposes a device that captures images of a plurality of subject regions partially overlapping with each other by using a plurality of cameras, transforms a plurality of captured images into bird's eye images while connecting (i.e., combining) the images together, and thereby displays the images on a display device as one continuous bird's eye display image (i.e. synthetic image). This device judges whether or not an obstacle exists in a region corresponding to a joint part (i.e., boundary line) in the bird's eye display image, and changes positions to become the joint part in the bird's eye display image when an obstacle exists in the region.

Further, Non-patent Reference 1 describes a technology of setting a virtual projection surface and generating a synthetic image by sticking an image captured by a camera to the virtual projection surface. Since adjoining images partially overlap with each other, the adjoining images are combined together by determining a boundary line between the adjoining images and performing the blending on images in the overlap region of the adjoining images based on the boundary line.
Patent Reference 1: Japanese Patent Application Publication No. 2007-41791.
Non-patent Reference 1: Matthew Brown and another, “Automatic Panoramic Image Stitching Using Invariant Features”, International Journal of Computer Vision, 74(1), pp. 59-73, 2007.

However, the above-described conventional methods have not considered a request that it is desirable to first execute the combining of a plurality of images and thereafter perform the blending on priority region images as images in a region that is desired to be displayed in the synthetic image with high priority (referred to also as a “priority region”). Specifically, the conventional methods have not considered superimposition of priority region images such as AR (Augmented Reality) images, CG (Computer Graphics) or processed CGI (Computer Generated Imagery). Therefore, when combining images including a priority region together, there are cases where images cannot be joined smoothly at the boundary line in the overlap region of adjoining images.

### SUMMARY OF THE INVENTION

An object of the present disclosure, which has been made to resolve the above-described problem, is to provide an image synthesis device, an image synthesis method and a storage medium storing program that make it possible to smoothly join images at the boundary line in the overlap region of adjoining images.

An image synthesis device in the present disclosure includes processing circuitry to acquire a plurality of images captured from different viewpoints and to select images adjoining each other from the plurality of images; to calculate an overlap region as a region where the adjoining images overlap with each other; to determine a boundary line between images in the overlap region; and to execute blending of images in the overlap region. When at least one of the adjoining images includes a priority region, the processing circuitry determines the boundary line that does not overlap with a blend region in a vicinity of the priority region as a region determined depending on a blending method used for blending of an image of the priority region, and the processing circuitry executes the blending of the images in the overlap region based on the boundary line.

An image synthesis method in the present disclosure is a method executed by an image synthesis device, the method including: acquiring a plurality of images captured from different viewpoints and selecting images adjoining each other from the plurality of images; calculating an overlap region as a region where the adjoining images overlap with each other; determining a boundary line between images in the overlap region; and executing blending of images in the overlap region. When at least one of the adjoining images includes a priority region, the determining a boundary line is a step of determining the boundary line that does not overlap with a blend region in a vicinity of the priority region as a region determined depending on a blending method used for blending of an image of the priority region, and the executing blending of images is a step of executing the blending of the images in the overlap region based on the boundary line

According to the present disclosure, smooth joining of images at the boundary line in the overlap region of adjoining images becomes possible.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a functional block diagram schematically showing a configuration of an image synthesis device according to a first embodiment;

FIG. 2 is a diagram showing an example of a subject and cameras that transmit image data to the image synthesis device according to the first embodiment;

FIG. 3 is a diagram showing an example of images acquired by an image acquisition unit of the image synthesis device according to the first embodiment;

FIG. 4 is a diagram showing an example of images selected by the image acquisition unit of the image synthesis device according to the first embodiment;

FIG. 5 is a diagram showing an example of an overlap region calculated by an overlap region calculation unit of the image synthesis device according to the first embodiment;

FIG. 6 is a diagram showing an example of a blend region determined based on a blending method determined by a blending unit of the image synthesis device according to the first embodiment;

FIG. 7 is a diagram showing an example of a boundary line determined by a boundary line determination unit of the image synthesis device according to the first embodiment;

FIG. 8 is a diagram showing an example of the hardware configuration of the image synthesis device according to the first embodiment;

FIG. 9 is a flowchart showing a process executed by the image synthesis device according to the first embodiment;

FIG. 10 is a flowchart showing a boundary line determination process in FIG. 9;

FIGS. 11A and 11B are diagrams showing warp images and mask images of images captured by cameras #1, #2 and #3;

FIG. 12 is a diagram showing an example of a weight map generation process;

FIG. 13 is a diagram showing an example of images acquired by an image acquisition unit of an image synthesis device according to a second embodiment;

FIG. 14 is a diagram showing an example of images selected by the image acquisition unit of the image synthesis device according to the second embodiment;

FIG. 15 is a diagram showing an example of an overlap region calculated by an overlap region calculation unit of the image synthesis device according to the second embodiment;

FIG. 16 is a diagram showing an example of a blend region based on a blending method determined by a blending unit of the image synthesis device according to the second embodiment;

FIG. 17 is a diagram showing an example of a boundary line determined by a boundary line determination unit of the image synthesis device according to the second embodiment;

FIG. 18 is a diagram showing an example of one image obtained by an integration by the image synthesis device according to the second embodiment;

FIG. 19 is a flowchart showing a process executed by the image synthesis device according to the second embodiment;

FIG. 20 is a diagram showing an example of a boundary line determined by a boundary line determination unit of an image synthesis device according to a third embodiment;

FIG. 21 is a diagram showing an example of images acquired by an image acquisition unit of an image synthesis device according to a fourth embodiment;

FIG. 22 is a diagram showing an example of a boundary line determined by a boundary line determination unit of the image synthesis device according to the fourth embodiment; and

FIG. 23 is a diagram showing an order of region division of overlapping images.

### DETAILED DESCRIPTION OF THE INVENTION

An image synthesis device, an image synthesis method and a program according to each embodiment will be described below with reference to the drawings. The following embodiments are just examples and it is possible to appropriately combine embodiments and appropriately modify embodiments.

### (1) FIRST EMBODIMENT

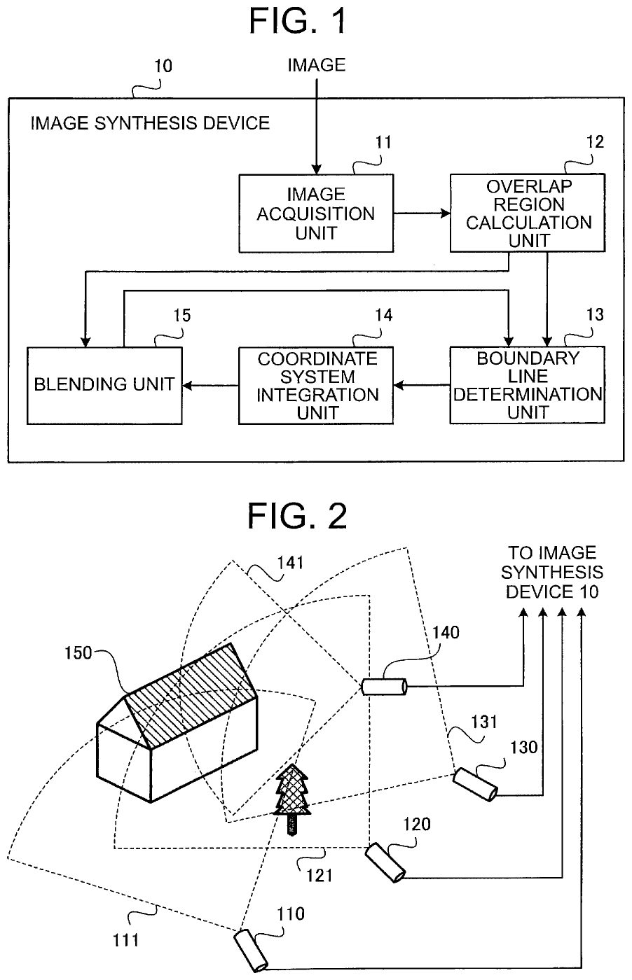

FIG. 1 is a functional block diagram schematically showing a configuration of an image synthesis device 10 according to a first embodiment. The image synthesis device 10 is a device capable of executing an image synthesis method according to the first embodiment. As shown in FIG. 1, the image synthesis device 10 includes an image acquisition unit 11, an overlap region calculation unit 12, a boundary line determination unit 13, a coordinate system integration unit 14 and a blending unit 15.

FIG. 2 is a diagram showing an example of a subject and cameras that transmit image data to the image synthesis device 10 according to the first embodiment. FIG. 2 shows a situation in which cameras 110, 120, 130 and 140 as image capturing devices respectively capture images of image capturing ranges 111, 121, 131 and 141. The cameras 110, 120, 130 and 140 have been set at/in positions/postures different from each other. In the example of FIG. 2, the cameras 110, 120, 130 and 140 are capturing images of a subject 150 including a house and a tree and transmitting image data to the image synthesis device 10. While four cameras 110, 120, 130 and 140 are shown in FIG. 2, it is also possible to use only one movable camera as long as the camera is configured to be able to transmit images captured from different viewpoints. Further, each camera 110, 120, 130, 140 can also be a movable camera having the pan-tilt-zoom functions or a movable camera having one or more of the pan-tilt-zoom functions.

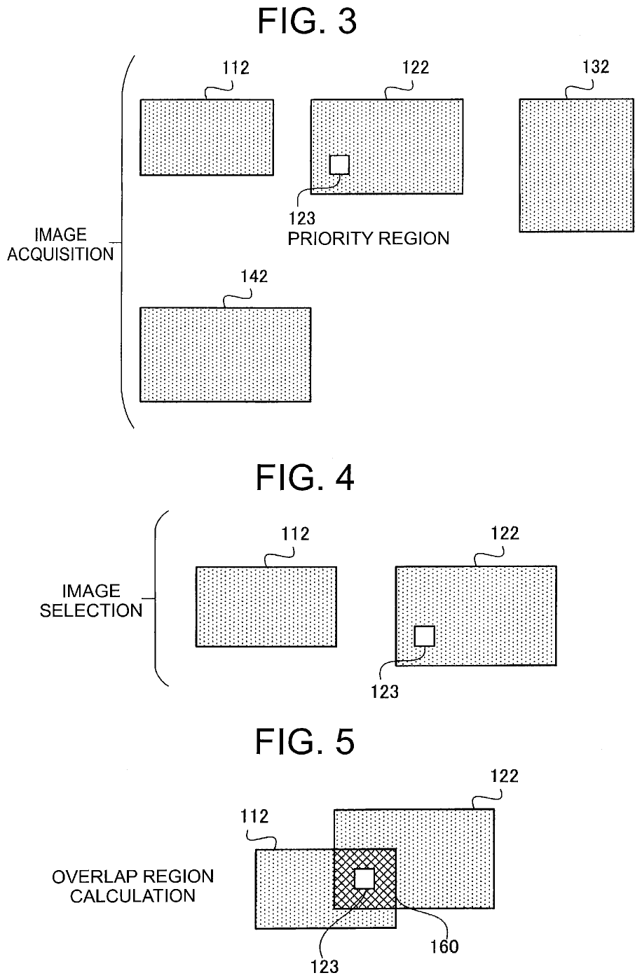

FIG. 3 is a diagram showing an example of images acquired by the image acquisition unit 11 of the image synthesis device 10. The image acquisition unit 11 acquires a plurality of images 112, 122, 132 and 142 captured from different viewpoints. The acquired images can be either still images or video images. FIG. 3 shows an example in which the image 122 includes a priority region 123. While the priority region in a narrow sense means a region that is desired to be displayed in the synthetic image with high priority, the priority region in a broad sense means either of a region that is desired to be displayed in the synthetic image with high priority and a region that is not desired to be displayed in the synthetic image (“removal region” in a fourth embodiment). In the present application, the term “priority region” is used in the broad sense. Namely, the priority region is an image region that is desired to be displayed in the synthetic image with high priority or an image region that is not desired to be displayed in the synthetic image (referred to also as a “removal region”). In the first embodiment, the priority region is a region where an AR image, CG, processed CGI or the like is displayed, for example.

FIG. 4 is a diagram showing an example of images selected by the image acquisition unit 11 of the image synthesis device 10. The image acquisition unit 11 selects two images having partially overlapping regions and adjoining each other from the plurality of acquired images. FIG. 4 shows a case where the images 112 and 122 have been selected. It is also possible for the image acquisition unit 11 to select three or more images having partially overlapping regions and adjoining each other from the plurality of acquired images.

FIG. 5 is a diagram showing an example of an overlap region calculated by the overlap region calculation unit 12 of the image synthesis device 10. The overlap region calculation unit 12 calculates an overlap region 160 as a region where the selected images overlap with each other. FIG. 5 shows a case where the priority region 123 is situated in the overlap region 160. The case where the priority region 123 is situated in the overlap region 160 includes not only a case where the whole of the priority region 123 exists in the overlap region 160 but also a case where part of the priority region 123 exists in the overlap region 160.

The blending unit 15 determines a blending method for blending images in the overlap region 160. In the example of FIG. 5, the blending unit 15 determines a blending method for the image of the priority region 123 (e.g., a blending method for the image of the priority region 123 and the image 122) and a blending method for the image 122 including the image of the priority region 123 and the image 112.

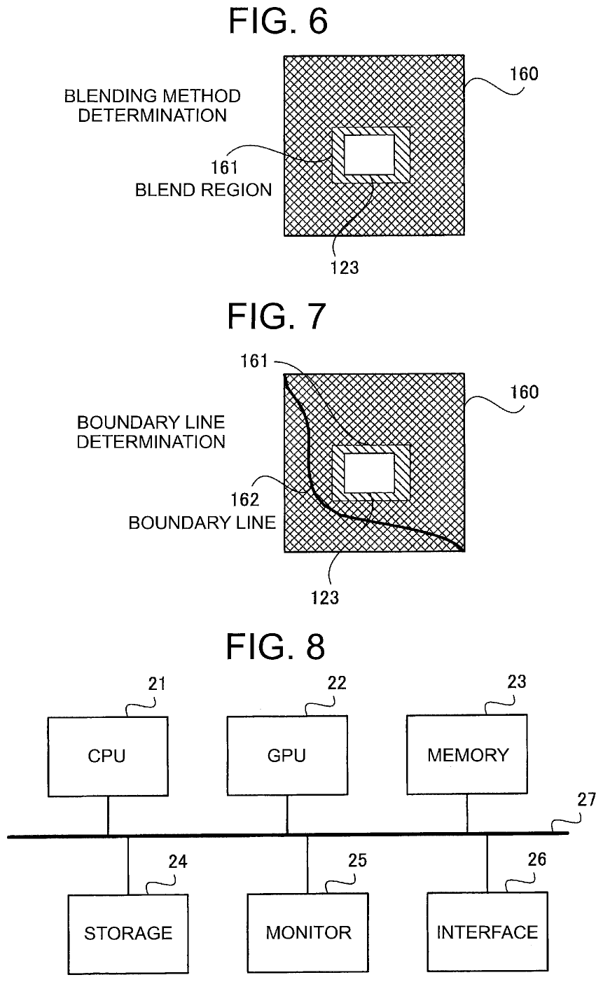

The boundary line determination unit 13 determines a boundary line between images in the overlap region 160. Specifically, the boundary line determination unit 13 determines the boundary line between the selected images. Namely, the boundary line determination unit 13 determines at what positions in the overlap region 160 the boundary line between the selected images should be drawn. When the images selected by the image acquisition unit 11 include the priority region 123, based on a blend region (e.g., 161 in FIG. 6 which will be explained later) in the vicinity of the priority region 123 as a region determined depending on the blending method used for the blending of the image of the priority region 123, the boundary line determination unit 13 determines a boundary line 162 that does not overlap with the blend region in the overlap region 160. There exist various types of region division algorithm as methods used for determining the boundary line between adjoining images. As the methods used for determining the boundary line, there exist a method employing a Voronoi diagram for dividing the overlap region 160 so that the area of one image and the area of the other image are equal to each other in the overlap region 160, a method employing a graph cut of dividing the overlap region 160 so as to avoid the subject, and so forth. See Non-patent Reference 2, for example.
Non-patent Reference 2: Vivek Kwatra and four others, “Graphcut Textures: Image and Video Synthesis Using Graph Cuts”, In ACM Transactions on Graphics (ToG), Vol. 22, pp. 277-286, ACM, 2003

The coordinate system integration unit 14 executes a process for integrating the coordinate systems of the selected images into the same coordinate system. The process by the coordinate system integration unit 14 does not need to be executed when the coordinate systems of the selected images are the same coordinate system or influence on the synthetic image is small even if the coordinate systems of the selected images are regarded as the same coordinate system.

FIG. 6 is a diagram showing an example of the blend region determined based on the blending method determined by the blending unit 15 of the image synthesis device 10. Upon the determination of the blending method for the image of the priority region 123 in the overlap region 160 by the blending unit 15, the shape of the blend region 161 around the priority region 123 is determined as shown in FIG. 6. For example, when multiband blending is employed as the blending method, the blend region 161 can be calculated since a Gaussian filter is applied to the image according to the number of bands. However, the employed blending method is not limited to multiband blending.

The blend region 161 is a vicinal region in the vicinity of the priority region 123 and is a region determined depending on the blending method. The blend region 161 can also be an expectation region determined according to a predetermined rule. For example, the blend region 161 can be a region generated by using a weight map in which the weight changes proportionally to the distance from the priority region 123 (i.e., a weight map based on a predetermined rule). In this case, the change in the weight determined by the weight map may be set as a linear change (i.e., gradient in a linear equation) of increasing or decreasing according to the distance from the priority region 123. Alternatively, the change in the weight determined by the weight map may be set not as a linear change but so as to change exponentially or logarithmically according to the distance from the priority region 123.

FIG. 7 is a diagram showing an example of the boundary line determined by the boundary line determination unit 13 of the image synthesis device 10. The blending unit 15 performs the blending on images in the overlap region 160 based on the boundary line determined by the boundary line determination unit 13. In the example of FIG. 7, the blending is performed on image parts in the overlap region 160 of the two images adjoining each other.

Multiband blending can be used for the blending of the images in the overlap region 160. See Non-patent Reference 3, for example. Multiband blending is algorithm of dividing an image into a plurality of frequency bands (bands), generating a plurality of image pyramids, and blending images in regard to each frequency band. For example, each image pyramid includes a plurality of images obtained by successively reducing the image resolution by half.
Non-patent Reference 3: Peter J Burt and another, “A Multiresolution Spline with Application to Image Mosaics”, ACM Transactions on Graphics (TOG), Vol. 2, No. 4, pp. 217-236, 1983.

However, a different blending method such as a blending method by means of feathering or Poisson blending may be used for the blending of images in the overlap region 160.

FIG. 7 shows a case where the priority region 123 is situated in the selected images. In this case, the boundary line determination unit 13 determines at what positions in the overlap region 160 the boundary line 162 between the adjoining images should be drawn based on the blend region 161 as the region determined in the overlap region 160 depending on the blending method. The boundary line determination unit 13 determines the boundary line 162 so as not to overlap with the blend region 161 in the overlap region 160. An example of a method of determining the boundary line 162 will be described below.

The boundary line determination unit 13 generates a weight map indicating weights of pixel values of an image in the overlap region 160. In general, when determining the boundary line, mask images respectively in the same sizes as the images are generated, and a region where the mask images are both white is judged to be the overlap region 160. In the overlap region 160, the boundary line determination unit 13 generates the weight map in consideration of the priority region 123 and the blend region 161.

When the graph cut described in the Non-patent Reference 2 is employed, a data term is defined based on a relationship between a pixel and a pixel in the overlap region of the two images, a smoothing term is defined based on a relationship between pixels in the overlap region, and the boundary line is determined so that an energy function represented as the sum of the data term and the smoothing term takes on a minimum value. In this case, since the overlapping images are on an equal footing, a value defined as “0” or a predetermined numerical value larger than 0 (e.g., “1”, hereinafter referred to also as a “large numerical value”) is input to the data term. For example, in the image 122 including the priority region 123, if the value of the data term is set at a “large numerical value” in the priority region 123 and the blend region 161 and set so as to decrease as it gets farther (i.e., with the increase in the distance) from the priority region 123 and the blend region 161, the boundary line 162 is determined nearby the priority region 123.

Furthermore, the value of the data term in the other image 112 is not dependent on the value of the data term in the image 122.

FIG. 8 is a diagram showing an example of the hardware configuration of the image synthesis device 10. However, the hardware configuration of the image synthesis device 10 is not limited to the configuration shown in FIG. 8.

The image synthesis device 10 is a computer, for example. The image synthesis device 10 includes a CPU (Central Processing Unit) 21, a GPU (Graphics Processing Unit) 22, a memory 23, storage 24, a monitor 25, an interface 26 and a bus 27. The bus 27 is a data transfer path used for data exchange in the hardware of the image synthesis device 10. The interface 26 is connected to the cameras, for example.

Functions of the image synthesis device 10 are implemented by processing circuitry. The processing circuitry can be either dedicated hardware or the CPU 21 executing a program (e.g., image synthesis program) as software stored in the memory 23. The CPU 21 can be any one of a processing device, an arithmetic device, a microprocessor, a microcomputer, a processor and a DSP (Digital Signal Processor).

In the case where the processing circuitry is dedicated hardware, the processing circuitry is, for example, a single circuit, a combined circuit, a programmed processor, a parallelly programmed processor, an ASIC (Application Specific Integrated Circuit), an FPGA (Field-Programmable Gate Array) or a combination of some of these circuits.

In cases where the processing circuitry includes the CPU 21, the functions of the image synthesis device 10 are implemented by software, firmware, or a combination of software and firmware. The software and the firmware are described as programs and stored in the memory 23. The processing circuitry implements the functions of the units by reading out and executing the program stored in the memory 23 as a storage device. The storage device may be a non-transitory computer-readable storage medium storing a program such as the program. Namely, the image synthesis device 10 executes the image synthesis method according to the first embodiment when a process is executed by the processing circuitry.

Here, the memory 23 can be, for example, any one of a nonvolatile or volatile semiconductor memory such as a RAM (Random Access Memory), a ROM (Read Only Memory), a flash memory, an EPROM (Erasable Programmable Read Only Memory) or an EEPROM (Electrically Erasable Programmable Read Only Memory), a magnetic disk, an optical disc, a compact disc, a DVD (Digital Versatile Disc), etc.

Furthermore, it is also possible to implement part of the image synthesis device 10 by dedicated hardware and part of the image synthesis device 10 by software or firmware. As above, the processing circuitry is capable of implementing the functions by hardware, software, firmware or a combination of some of these means. Furthermore, the configuration shown in FIG. 8 is applicable also to image synthesis devices in second to fifth embodiments which will be described later.

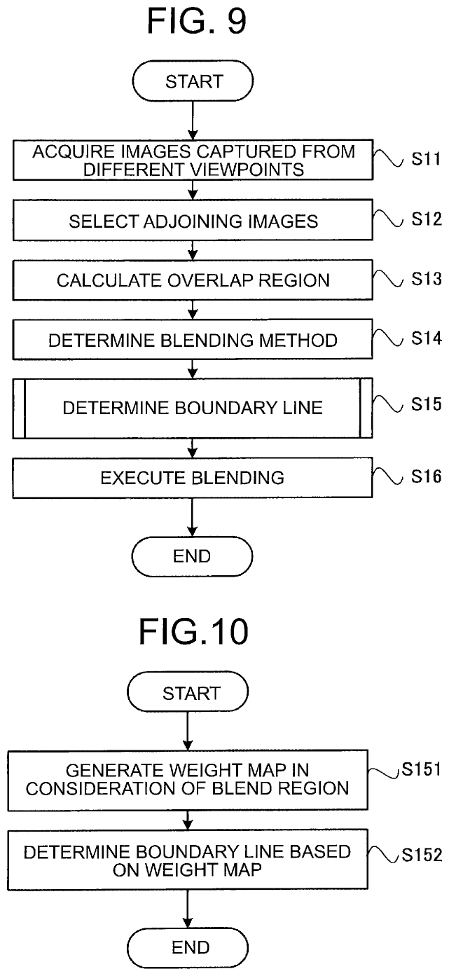

FIG. 9 is a flowchart showing a process executed by the image synthesis device 10. However, the process executed by the image synthesis device 10 is not limited to that shown in FIG. 9.

The image acquisition unit 11 acquires a plurality of images obtained by camera capturing from different viewpoints in step S11, and selects two images adjoining each other from the plurality of images in step S12. In step S13, the overlap region calculation unit 12 calculates the overlap region 160 of the two images selected by the image acquisition unit 11.

In step S14, the blending unit 15 determines the blending method to be used for the combining of the two images (including the image in the priority region 123 when the priority region 123 exists) selected by the image acquisition unit 11. In step S15, the boundary line determination unit 13 determines the boundary line 162 in the overlap region 160 calculated by the overlap region calculation unit 12. In step S16, after the boundary line 162 is determined, the blending unit 15 executes the blending of images in the overlap region 160.

Furthermore, when necessary, the coordinate system integration by the coordinate system integration unit 14 is executed before the blending.

FIG. 10 is a flowchart showing the boundary line determination process (step S15) in FIG. 9. However, the boundary line determination process is not limited to that shown in FIG. 10. In step S151, the boundary line determination unit 13 generates the weight map in consideration of the blend region.

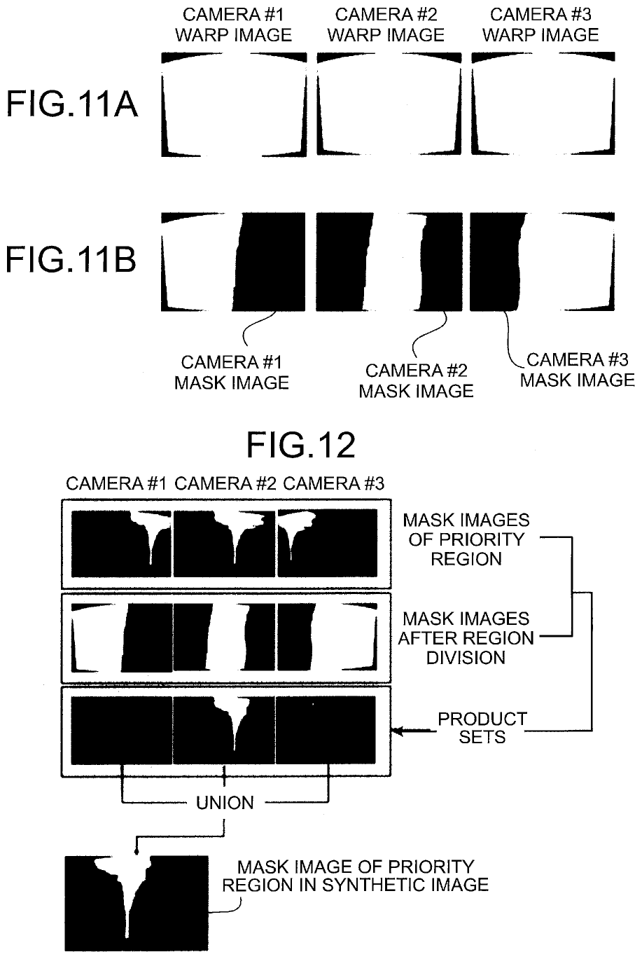

FIGS. 11A and 11B are diagrams showing warp images and mask images of images captured by cameras #1, #2 and #3. For example, in general, when determining the boundary line, white mask images respectively in the same sizes as the images are generated as shown as warp images in FIG. 11A, and an overlap region of white mask images is judged to be a mask as shown as mask images in FIG. 11B. When the priority region and the blend region exist in the overlap region, the boundary line determination unit 13 generates the weight map in the overlap region in consideration of the priority region and the blend region.

FIG. 12 is a diagram showing an example of the weight map generation process. In rules shown in FIG. 12, the captured image from each of the cameras #1, #2 and #3 includes a priority region (e.g., a region of the tree in FIG. 2, namely, a removal region), and in regard to each of the captured images from the cameras #1, #2 and #3, a product set of the mask image of the priority region and the mask image after the region division is calculated. Further, a union of the mask images regarding the cameras #1, #2 and #3 obtained as the product sets is calculated. Consequently, a mask image of the priority region (removal region in FIG. 12) in the synthetic image (e.g., panorama image formed from the captured images from the cameras #1, #2 and #3) is obtained. Furthermore, the rules for forming the mask image are not limited to those shown in FIG. 12.

In step S152, the blending unit 15 determines the pixel value of each pixel based on the weight map and performs the blending on the images in the overlap region based on the boundary line 162. Namely, the blending unit 15 performs the blending on the images in the overlap region based on the three mask images after the region division regarding the cameras #1, #2 and #3 shown in FIG. 12 and the one mask image of the priority region in the synthetic image shown in FIG. 12, for example. After the boundary line and the blending method are determined, it is also possible for the blending unit 15 to parallelly write pixels of the images to the memory storing the synthetic image.

As described above, with the image synthesis device 10 according to the first embodiment, smooth joining of images at the boundary line 162 in the overlap region 160 of the images is possible not only in cases where a synthetic image is generated by combining images including no priority region together but also in cases where a synthetic image is generated by combining images including a priority region together.

Further, with the image synthesis device 10 according to the first embodiment, the process of combining a plurality of images together can be executed efficiently compared to a device or method that separately execute first blending as a process of determining the boundary line of the selected images and joining the images together and second blending as a process of synthesizing an image of the priority region in the overlap region of the images. In other words, with the image synthesis device 10 according to the first embodiment, a process of determining the boundary line by using the weight map generated based on the priority region and the blend region and performing the blending on the images in the overlap region based on the boundary line is executed, and thus the image synthesis process can be executed efficiently.

### (2) SECOND EMBODIMENT

In a second embodiment, a description will be given of a case where the image acquisition unit 11 of the image synthesis device 10 acquires a plurality of images including priority regions and the acquired images are combined together. Except for this feature, the second embodiment is the same as the first embodiment. Thus, FIG. 1, FIG. 2, FIG. 8 and FIG. 10 are also referred to in the description of the second embodiment.

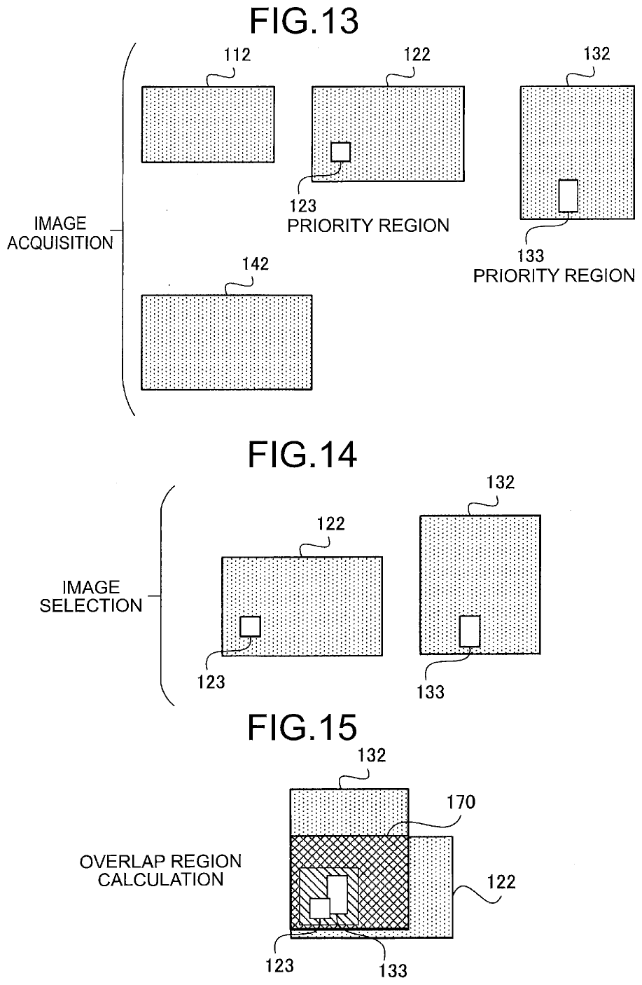

FIG. 13 is a diagram showing an example of images acquired by the image acquisition unit 11 of the image synthesis device 10. The image acquisition unit 11 acquires a plurality of images 112, 122, 132 and 142 captured from different viewpoints. FIG. 13 shows an example in which the image 122 includes a priority region 123 and the image 132 includes a priority region 133.

FIG. 14 is a diagram showing an example of images selected by the image acquisition unit 11 of the image synthesis device 10. The image acquisition unit 11 selects two images having partially overlapping regions and adjoining each other from the plurality of acquired images. FIG. 14 shows a case where the images 122 and 132 have been selected.

FIG. 15 is a diagram showing an example of the overlap region calculated by the overlap region calculation unit 12 of the image synthesis device 10. The overlap region calculation unit 12 calculates an overlap region 170 as a region where the selected images overlap with each other. FIG. 15 shows a case where the priority regions 123 and 133 are situated in the overlap region 170 and the priority regions 123 and 133 partially overlap with each other.

The blending unit 15 determines the blending method in the overlap region 170. Further, the blending unit 15 may determine a blending method for a region where the priority regions 123 and 133 overlap with each other.

The boundary line determination unit 13 determines at what positions in the overlap region 170 the boundary line between the selected images should be drawn. Further, the boundary line determination unit 13 determines at what positions a boundary line between the priority regions 123 and 133 of the selected images should be drawn.

The coordinate system integration unit 14 executes the process for integrating the coordinate systems of the selected images into the same coordinate system. The process by the coordinate system integration unit 14 does not need to be executed when the coordinate systems of the selected images are the same coordinate system or influence on the synthetic image is small even if the coordinate systems of the selected images are regarded as the same coordinate system.

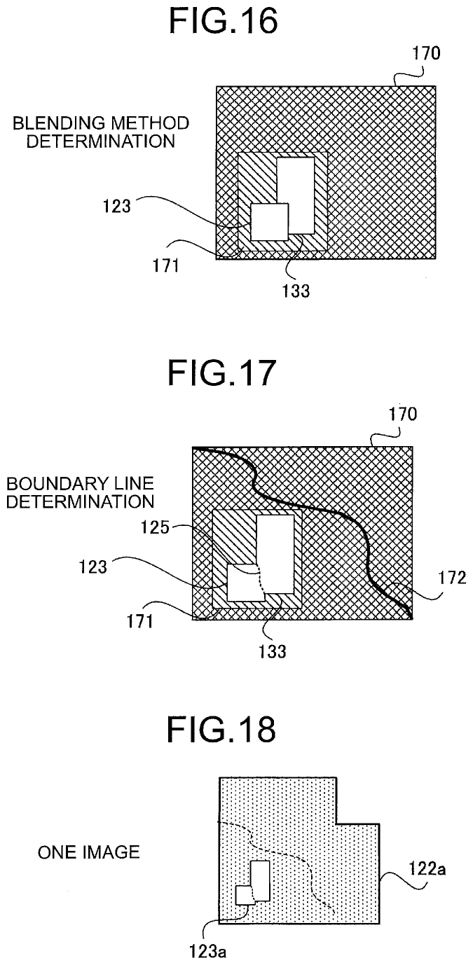

FIG. 16 is a diagram showing an example of the blend region determined based on the blending method determined by the blending unit 15 of the image synthesis device 10. Upon the determination of the blending method in the overlap region 170 by the blending unit 15, the shape of a blend region 171 around the priority regions 123 and 133 is determined as shown in FIG. 16. The blending method is the same as that in the first embodiment.

FIG. 17 is a diagram showing an example of the boundary line determined by the boundary line determination unit 13 of the image synthesis device 10. The blending unit 15 performs the blending on the overlap region 170 of the two images adjoining each other based on a boundary line 172 determined by the boundary line determination unit 13.

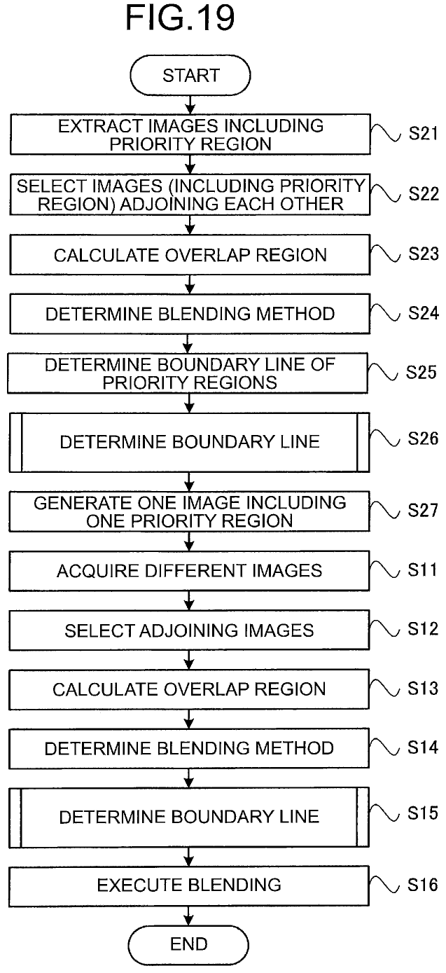

FIG. 18 is a diagram showing an example of one image obtained by the integration by the image synthesis device 10. In the example of FIG. 18, an image 122a obtained by the integration into one image includes a priority region 123a obtained by the integration into one priority region.

FIG. 19 is a flowchart showing a process executed by the image synthesis device 10. The flowchart shown in FIG. 10 differs from the flowchart in the first embodiment shown in FIG. 9 in that steps S21 to S27 have been added. However, the process executed by the image synthesis device 10 is not limited to that shown in FIG. 19.

The image acquisition unit 11 acquires a plurality of images camera-captured from different viewpoints in the step S21, and selects two images (including a priority region) adjoining each other from the plurality of images in the step S22. In the step S23, the overlap region calculation unit 12 calculates the overlap region 170 of the two images selected by the image acquisition unit 11.

In the step S24, the blending unit 15 determines the blending method to be used for the combining of the two images selected by the image acquisition unit 11. In the step S25, the boundary line determination unit 13 determines the boundary line 172 between the images 132 and 122 in the overlap region 170 and a boundary line 125 between the images of the priority regions 123 and 133 based on the overlap region 170 calculated by the overlap region calculation unit 12 as shown in FIG. 17. In the step S26, after the determination of the boundary line 172, the blending unit 15 performs the blending on the overlap region 170, and one image 122a including one priority region 123a is formed in the step S27. Furthermore, the integration of the coordinate systems by the coordinate system integration unit 14 may be executed before the blending. Further, the process shown in FIG. 10 is executed in the process in the step S26.

The process in the steps S11 to S16 is the same as that shown in FIG. 9.

As described above, with the image synthesis device 10 according to the second embodiment, smooth joining of images at the boundary line 172 in the overlap region 170 of the images is possible not only in cases where a synthetic image is generated by combining images including no priority region together but also in cases where a synthetic image is generated by combining images including a priority region together.

Further, in the second embodiment, when the plurality of images acquired by the image acquisition unit 11 include two or more images 122, 132 respectively including priority regions 123, 133, the overlap region calculation unit 12, the blending unit 15 and the boundary line determination unit 13 execute an integration process (steps S21 to S27) of transforming the images 122, 132 respectively including the priority regions 123, 133 into the integrated image 122a. Further, when the priority regions 123 and 133 overlap with each other, the overlap region calculation unit 12, the blending unit 15 and the boundary line determination unit 13 transform the two priority regions 123 and 133 into one integrated priority region 123a by combining the priority regions 123 and 133 together. Thus, even when a plurality of images 122, 132 respectively including priority regions 123, 133 are inputted, smooth joining of images at the boundary line 172 in the overlap region 170 of the images is possible.

Furthermore, with the image synthesis device 10 according to the second embodiment, the process of combining a plurality of images together can be executed efficiently compared to a device or method that separately execute the first blending as the process of determining the boundary line of the selected images and joining the images together and the second blending as the process of synthesizing an image of the priority region in the overlap region of the images. In other words, with the image synthesis device 10 according to the second embodiment, a process of determining the boundary line by using the weight map generated based on the integrated image 122a and the blend region and performing the blending on the images in the overlap region based on the boundary line is executed, and thus the image synthesis process can be executed efficiently.

### (3) THIRD EMBODIMENT

While examples of cases where the pixel values of the image of the priority region are 100% and the pixel values of the image overlapping with the priority region are 0% in the image synthesis device 10 are described in the above first and second embodiments, an example in which the pixel values of the image of the priority region are larger than 0% and smaller than 100%, namely, the image of the priority region is semitransparent, will be described in a third embodiment. The third embodiment is applicable to the first and second embodiments. Except for this feature, the third embodiment is the same as the first or second embodiment. Thus, FIG. 1, FIG. 2 and FIG. 8 to FIG. 10 are also referred to in the description of the third embodiment.

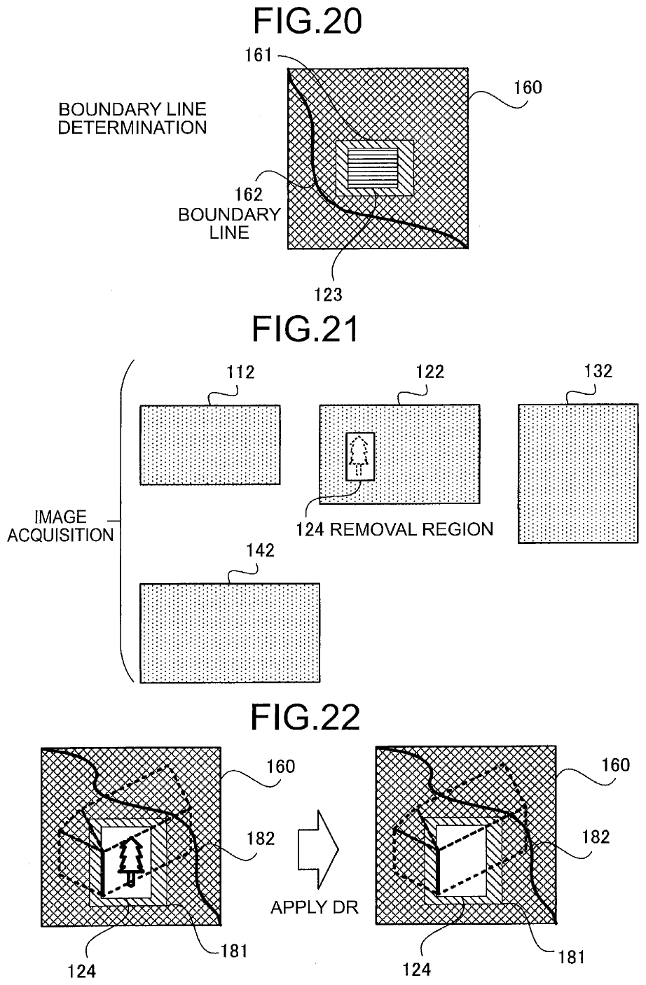

FIG. 20 is a diagram showing an example of the boundary line determined by the boundary line determination unit 13 of an image synthesis device 10 according to the third embodiment. In the third embodiment, a description will be given of a case where the pixel values of the image of the priority region 123 are set at 70% and a background image overlapping with the priority region 123 is also displayed. While the operation in the third embodiment is similar to that shown in FIG. 9 and FIG. 10, semitransparent display is employed by setting the pixel values of the priority region 123 at 70% and performing a blending, for example, and the a value is determined so that the α value equals 70% at the quadrangular boundary line of the priority region 123. Further, since the background of the priority region 123 becomes necessary in that case, the image of the background is also determined in the step S15 in FIG. 9. The α value can also be a different value (i.e., a value other than 70%) smaller than 100%.

As described above, with the image synthesis device 10 according to the third embodiment, smooth joining of images at the boundary line 162 in the overlap region 160 of the images is possible not only in cases where a synthetic image is generated by combining images including no priority region together but also in cases where a synthetic image is generated by combining images including a priority region together. Further, smooth joining of images at the boundary line in the overlap region of the images is possible even in cases where a synthetic image is generated by combining images including a semitransparent priority region together.

Furthermore, with the image synthesis device 10 according to the third embodiment, the process of combining a plurality of images together can be executed efficiently compared to a device or method that separately execute the first blending as the process of determining the boundary line of the selected images and joining the images together and the second blending as the process of synthesizing an image of the priority region in the overlap region of the images. In other words, with the image synthesis device 10 according to the third embodiment, a process of determining the boundary line by using the weight map generated based on the priority region and the blend region and performing the blending on semitransparent images in the overlap region based on the boundary line is executed, and thus the image synthesis process can be executed efficiently.

### (4) FOURTH EMBODIMENT

In the above first to third embodiments, the description is given of examples in which the image synthesis device 10 executes a process of synthesizing an image including a priority region. In a fourth embodiment, a description will be given of an example in which the priority region is a region in which a removal object in the diminished reality (DR) technology exists (i.e., the removal region) and the priority region image is an image of a region of a hidden background as a background that was hidden by the removal object. The fourth embodiment is applicable to the first to third embodiments. Except for these features, the fourth embodiment is the same as any one of the first to third embodiments. Thus, FIG. 1, FIG. 2 and FIG. 8 to FIG. 10 are also referred to in the description of the fourth embodiment.

For example, in the DR technology (see Non-patent Reference 4) as one of application modes of AR, there are cases where it is desired to generate a house, as a background (hidden background) screened by a removal object (e.g., the tree in FIG. 2), by using an image from a camera at a different viewpoint (a hidden background camera) and synthesize an image so that the region of the hidden background is not hidden. Namely, there are cases where it is desired to generate an image from which the removal object has been removed.
Non-patent Reference 4: Shohei Mori, Ryosuke Ichikari, Fumihisa Shibata, Asako Kimura, and Hideyuki Tamura, “Framework and Technical Issues of Diminished Reality: A Survey of Technologies That Can Visually Diminish the Objects in the Real World by Superimposing, Replacing, and Seeing-Through”, TVRSJ (Transactions of the Virtual Reality Society of Japan), Vol. 16, No. 2, pp. 239-250, June 2011.

When the boundary line is determined by an already existing method, if a mask process is executed so that the overlap region does not include the priority region (such as a removal region), the boundary line never enters the priority region. However, while pixel values of overlapping images are blended together in the subsequent blending, there is a possibility that the blending is not done smoothly when the boundary line is too close to the priority region.

In the fourth embodiment, a description will be given of an example in which the priority region is a region including a removal object. In this case, the priority region is referred to as the “removal region”. Also in this case, the boundary line is determined so as not to overlap with the priority region similarly to the cases in the first to third embodiments.

FIG. 21 is a diagram showing an example of images acquired by the image acquisition unit 11 of an image synthesis device 10 according to the fourth embodiment. FIG. 22 is a diagram showing an example of the boundary line determined by the boundary line determination unit 13 of the image synthesis device 10 according to the fourth embodiment.

The image acquisition unit 11 acquires a plurality of images 112, 122, 132 and 142 captured from different viewpoints. FIG. 21 shows an example in which the image 122 includes a removal region 124.

While the operation in the fourth embodiment is basically the same as the operation in the first embodiment shown in FIG. 9 and FIG. 10, the weight map generated in the step S151 differs from that in the first embodiment. When the graph cut described in the Non-patent Reference 2 is employed and a black image is used as the mask image, the data term in the images of the removal region 124 and a blend region 181 is 0.

Definitions of regions other than the blend region 181 are the same as those in the first embodiment. For example, in the image 122 including the removal region 124, the value of the data term in the removal region 124 and the blend region 181 is set at 0 and the value of the data term is set so as to gradually increase as it gets farther (i.e., with the increase in the distance) from the removal region 124 and the blend region 181. In this case, a boundary line 182 is determined nearby the removal region 124. After the determination of the boundary line 182, the blending unit 15 executes the blending of images in the overlap region 160. Furthermore, when necessary, the coordinate system integration by the coordinate system integration unit 14 is executed before the blending.

As described above, with the image synthesis device 10 according to the fourth embodiment, smooth joining of images at the boundary line in the overlap region of the images is possible even in cases where a synthetic image is generated by combining images including a removal region as a type of the priority region together.

Further, with the image synthesis device 10 according to the fourth embodiment, the process of combining a plurality of images together can be executed efficiently compared to a device or method that separately execute the first blending as the process of determining the boundary line of the selected images and joining the images together and the second blending as the process of synthesizing an image of the removal region in the overlap region of the images. In other words, with the image synthesis device 10 according to the fourth embodiment, a process of determining the boundary line by using the weight map generated based on the removal region and the blend region and performing the blending on the images in the overlap region based on the boundary line is executed, and thus the image synthesis process can be executed efficiently.

### (5) FIFTH EMBODIMENT

In the above first to fourth embodiments, the description is given of processes of combining two images together. In a fifth embodiment, a description will be given of a case where three images include an overlap region of overlapping with each other and a synthetic image is generated from these images. Furthermore, a method of generating a synthetic image from four or more images can be executed similarly to the method of generating a synthetic image from three images. The fifth embodiment is applicable to the first to fourth embodiments. Except for these features, the fifth embodiment is the same as any one of the first to fourth embodiments. Thus, FIG. 1, FIG. 2 and FIG. 8 to FIG. 10 are also referred to in the description of the fifth embodiment.

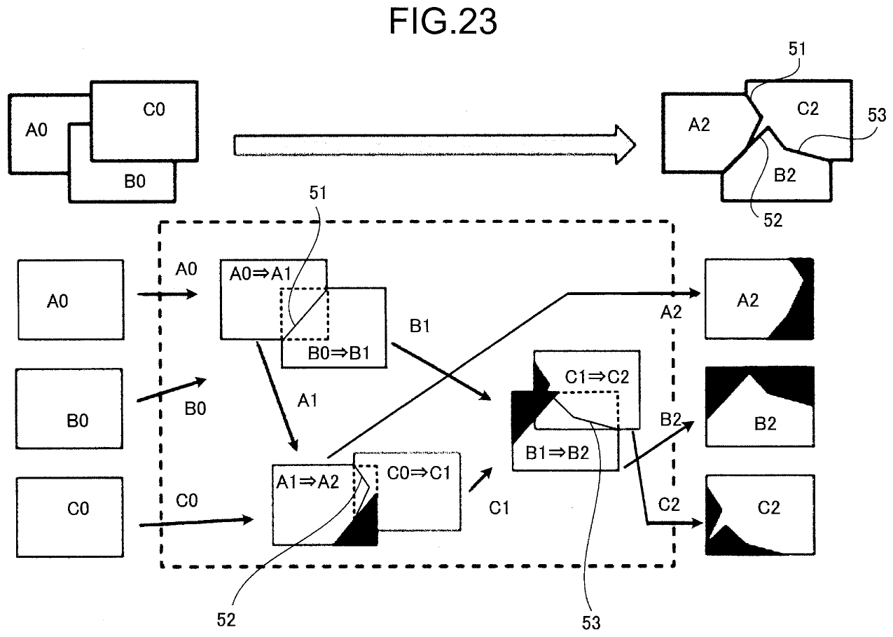

FIG. 23 is a diagram showing the order of the region division of overlapping images. In general, the boundary line in a region where a plurality of (three or more) images overlap can be determined by executing the region division of any two images among the plurality of selected images in regard to all combinations.

The boundary line determination unit 13 of an image synthesis device 10 according to the fifth embodiment sets the order of determining boundary lines 51, 52 and 53 of three images A0, B0 and C0 selected as adjoining images, namely, the order of the region division as the process of dividing the overlap region by the boundary lines 51, 52 and 53, so that the region division is performed latter on a layer that is more desired to exist among the layers of the plurality of images. For example, in order to reduce the area of regions not used in the generation of the synthetic image, the region division of an image that is more desired to exist as an image as a layer over the other images is desired to be executed in a latter process.

In the example of FIG. 23, first, the boundary line 51 in the overlap region of the image A0 and the image B0 is calculated and an image A1 and an image B1 excluding regions not used are generated. Subsequently, the boundary line 52 in the overlap region of the image A1 and the image C0 is calculated and an image A2 and an image C1 excluding regions not used are generated. Subsequently, the boundary line 53 in the overlap region of the image B1 and the image C1 is calculated and an image B2 and an image C2 excluding regions not used are generated. The regions not used in the generation of the synthetic image are the blackened regions in the images A2, B2 and C2 in FIG. 23. The synthetic image is the image in FIG. 23 made up of the images A2, B2 and C2.

As is understandable from FIG. 23, in order to reduce the area of image regions not used in an image that is desired to exist as a layer over the other images, it is desirable to perform the region division on an image that is more desired to exist as a layer over the other images in a latter process.

As described above, with the image synthesis device 10 according to the fifth embodiment, smooth joining of images at the boundary line in the overlap region of the images is possible even in cases where a synthetic image is generated by synthesizing an image of a priority region (which can be a removal region). Further, when three or more overlapping images are combined together, the area of regions not used in the image that is desired to exist as a layer over the other images can be reduced.

Furthermore, with the image synthesis device 10 according to the fifth embodiment, the process of combining a plurality of images together can be executed efficiently compared to a device or method that separately execute the first blending as the process of determining the boundary line of the selected images and joining the images together and the second blending as the process of synthesizing an image of the priority region in the overlap region of the images.

### (6) DESCRIPTION OF REFERENCE CHARACTERS

10: image synthesis device; 11: image acquisition unit; 12: overlap region calculation unit; 13: boundary line determination unit; 14: coordinate system integration unit; 15: blending unit; 110, 120, 130, 140: camera; 112, 122, 132, 142: image; 123, 133: priority region; 122a: integrated image; 123a: integrated priority region; 124: removal region; 125: boundary line of priority regions; 150: subject; 160, 170: overlap region; 162, 172, 182: boundary line; 161, 171, 181: blend region.

What is claimed is:

1. An image synthesis device comprising:
processing circuitry
to acquire a plurality of images captured from different viewpoints and to select images adjoining each other from the plurality of images;
to calculate an overlap region as a region where the adjoining images overlap with each other;
to determine a boundary line between images in the overlap region; and
to execute blending of images in the overlap region,
wherein when at least one of the adjoining images includes a priority region, the processing circuitry determines the boundary line that does not overlap with a blend region in a vicinity of the priority region as a region determined depending on a blending method used for blending of an image of the priority region, and the processing circuitry executes the blending of the images in the overlap region based on the boundary line,
wherein when a region division process of dividing an overlap region of the plurality of images at the boundary line is executed successively for different overlap regions, the processing circuitry executes the region division regarding an image that is more desired to exist as an image as a layer over other images as a latter process.

2. The image synthesis device according to claim 1, wherein the processing circuitry
generates a weight map of pixel values in the overlap region based on the blend region, and
determines the boundary line based on the weight map.

3. The image synthesis device according to claim 2, wherein
the weight map has a weight at a predetermined large numerical value in the blend region, and
the weight decreases with an increase in distance from the blend region.

4. The image synthesis device according to claim 1, wherein when the image of the priority region is a semitransparent image and the processing circuitry employs a blending, an α value at a boundary of the priority region is set at a value smaller than 100%.

5. The image synthesis device according to claim 2, wherein
the weight map has a weight of 0 in the blend region, and
the weight increases with an increase in distance from the blend region.

6. The image synthesis device according to claim 1, wherein when the plurality of images acquired by the processing circuitry include two or more images each including a priority region, the overlap region calculation unit, the processing circuitry executes an integration process of transforming the images each including the priority region into an integrated image and generates a synthetic image from the integrated image and images not undergone the integration process among the plurality of images acquired by the processing circuitry.

7. The image synthesis device according to claim 1, wherein when priority regions in two or more images each including the priority region overlap with each other, the processing circuitry combines two of the priority regions together into one integrated priority region.

8. An image synthesis method executed by an image synthesis device, the method comprising:
acquiring a plurality of images captured from different viewpoints and selecting images adjoining each other from the plurality of images;
calculating an overlap region as a region where the adjoining images overlap with each other;
determining a boundary line between images in the overlap region; and
executing blending of images in the overlap region,
wherein when at least one of the adjoining images includes a priority region, the determining a boundary line is a step of determining the boundary line that does not overlap with a blend region in a vicinity of the priority region as a region determined depending on a blending method used for blending of an image of the priority region, and the executing blending of images is a step of executing the blending of the images in the overlap region based on the boundary line,
wherein when a region division process of dividing an overlap region of the plurality of images at the boundary line is executed successively for different overlap regions, the processing circuitry executes the region division regarding an image that is more desired to exist as an image as a layer over other images as a latter process.

9. A program that causes a computer to execute a process, the process comprising:
acquiring a plurality of images captured from different viewpoints and selecting images adjoining each other from the plurality of images;
calculating an overlap region as a region where the adjoining images overlap with each other;
determining a boundary line between images in the overlap region; and
executing blending of images in the overlap region,
wherein when at least one of the adjoining images includes a priority region, the determining a boundary line is a step of determining the boundary line that does not overlap with a blend region in a vicinity of the priority region as a region determined depending on a blending method used for blending of an image of the priority region, and the executing blending of images is a step of executing the blending of the images in the overlap region based on the boundary line,
wherein when a region division process of dividing an overlap region of the plurality of images at the boundary line is executed successively for different overlap regions, the processing circuitry executes the region division regarding an image that is more desired to exist as an image as a layer over other images as a latter process.
